(19) United States
(12) Patent Application Publication
(10) Pub. No.: US 2007/0011047 A1
(43) Pub. Date: Jan. 11, 2007

(54) Membership-based travel discount system

(76) Inventor: Hamid Daoudi, Berkeley, CA (US)

Correspondence Address: Hamid Daoudi, Suite 10A, 930 Dwight Way, Berkeley, CA, 94710-2560, US

(21) Appl. No.: 11/178,927

(22) Filed: Jul. 11, 2005

(51) Int. Cl. G06Q 30/00; G06Q 10/00

(52) U.S. Cl. 705/14; 705/5

(57) ABSTRACT

This invention relates generally to a system that offers participants discounts on their travel tickets on all types of seatings, airlines, and destinations. The system is membership-based where members at different levels of participation and payments receive corresponding travel-related benefits and discounts on their airline travel purchases without the need for advanced reservation.

### CROSS-REFERENCE TO RELATED APPLICATIONS

Not applicable.

### STATEMENT AS TO RIGHTS TO INVENTIONS MADE UNDER FEDERALLY SPONSORED RESEARCH AND DEVELOPMENT

Not applicable.

### FIELD OF THE INVENTION

This invention relates generally to a system that offers participants discounts on their travel tickets on all types of seatings, airlines, and destinations. The system is membership-based where members at different levels of participation and payments receive corresponding travel-related benefits and discounts on their airline travel purchases without the need for advanced reservation.

### BACKGROUND OF THE INVENTION

Airplane travel is an essential part of modern life. Due to the fluctuation of the economy and the high prices of oil, air travelers have suffered enormous increases in airfares. Even with months of advanced bookings, travelers have to pay hefty prices for airplane tickets. Buying an airplane ticket without an advanced booking in response to an emergency or an unexpected change of plans is financially prohibitive for most travelers. As with all types of financial transactions, this invention recognizes the power of group purchasing or wholesale discounts. This invention seeks to offer people who subscribe to its service discounted travel tickets at any time and with or without advanced purchases. In return for a multi-level yearly subscription, participants obtain proportionately corresponding discounts on multiple travel tickets and other travel-related benefits and services during subscription.

### SUMMARY OF THE INVENTION

The invention provides a method of offering discounted travel tickets and other travel-related benefits and services for subscribers without advanced reservation based on a computerized membership system. At least one provider's computer has a database for the storage and retrieval of information. The database stores names of participant subscribers who are enlisted upon payment of a predetermined fee. The provider offers discounted travel tickets, including airplane tickets, and travel-related benefits and services such as hotel reservations, car rentals, and other various services and upgrades for all participants depending on the level of service subscribed to. The provider offers the discounted rates, benefits, and services without the need for advanced notice or reservation. The provider obtains the discounted rates, benefits, and services on behalf of its subscribers from different airline companies, travel tickets providers, hotels, car rental companies, and any other companies providing travel-related services and passes them to the subscribers upon request. The provider offers one or more plans. The plan or each plan offered by the provider is subscribed to by participants upon a payment of predetermined fee. The amounts of discounts and levels of benefits correspond with the type of subscription. What is unique about this method is that it offers its subscribers tickets at discounted rates without the need to reserve a seat or book a flight in advance.

### DETAILED DESCRIPTION OF THE INVENTION

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to computer codes, card codes, methods, systems, and computer program products according to various aspects of the invention. It will be understood that each such description can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in each of the described references.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the described reference. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the described reference.

Accordingly, each described reference such as to computer codes, card codes, methods, systems, and computer program products supports combinations of means for performing the specified functions, combinations of steps for performing the specified functions, and program instruction means for performing the specified functions of this invention. It will also be understood that each described reference or combination thereof can be implemented by either special purpose hardware-based computer systems which perform the specified functions or steps, or suitable combinations of special purpose hardware and computer instructions.

In a preferred embodiment, the present invention provides a method of offering discounted travel tickets and other travel-related benefits and services for subscribers without advanced reservation based on a computerized membership system. The consumer participant selects a particular level of subscription by paying a predetermined fee to enroll. The participant can obtain discounted travel tickets from the provider without advanced notice. The level of discount is explained by the provider at the time of subscription. The discount can be offered as a percentage on any travel tickets requested by the participant. In another embodiment, the discount can be in the form of providing a cheaper travel ticket to and from the requested destinations of the participant. In another embodiment, the discounted travel tickets are offered as a rebate from the provider. All such embodiments and many other benefits are disclosed and explained to the participants at the time of subscription. The participant can obtain additional travel-related services and benefits from the provider upon request or based on a list of benefits provided to the participant upon subscription.

In a different embodiment, this invention provides a method and system of issuing a membership to a user. In another embodiment, the user member selects a plan of participation from a number of multiple plans by paying a predetermined fee set by the provider. In another embodiment, the provider obtains discounts on travel tickets and travel-related services and benefits and passes them to its participant members. In another embodiment, the provider customizes the membership account of each participant member in accordance with the instructions of such member at the time of enrolling or at any other time.

A representative method for practicing the method and system invention is comprised of the following steps: membership provider obtains travel discounts and services from travel ticket providers and travel-related services providers, members participate with the membership provider for a predetermined fee, and the membership provider passes the discounts and services to participant members for the predetermined fee.

The system and method maximize the revenues for the travel ticket providers and travel-related services providers by offering group purchasers and users. The membership participants obtain discounted travel tickets and travel-related services due to their cumulative buying power. The membership is sold as a retail item or simply upon contacting the membership provider.

In another embodiment of the invention, the participant member can obtain the discounts and other travel-related benefits without the assistance of membership agents. The method includes providing a product package, facilitating travel-related purchases, and other travel-related benefits and discounts upon identifying the traveler as an active member of the provider. Use of the product package or any other travel-related benefits and discounts are paid for at a discount by the provider. Use of the product package or any other travel-related benefits and discounts are traced by the provider using a membership card, which is presented at the time of use with participant providers. The card includes a tracking code and a membership number. The tracking code is transmitted or recorded by the participant provider. Such transmission or recordation is reported to the membership provider and is used to update the history of the membership user. After the history update, a member user would have exhausted a portion of his membership benefits and may receive additional or no benefits depending on the level of participation and plan he/she is enrolled in with the membership provider.

In another embodiment of the invention, a participant member is issued a card upon enrolling in a plan. After the card has been issued, the member user interacts with the service provider, i.e., airline provider, to obtain a predetermined discount corresponding with the level of his plan at any time in advance of his/her travel. Additional benefits and discounts are provided by different providers. The member user will obtain all such benefits and discounts upon presenting the card and exhausting the corresponding privileges associated with his/her plan level.

In another embodiment of the invention, the system provides for an integrated travel market brokers that offer travel discounts and benefits for a single provider. The single provider passes such discounts and benefits to participating members upon a payment of a predetermined fee. The travel network requires periodic updating but may not require constant monitoring.

It should be appreciated that the particular implementations shown and described herein are illustrative of the invention and its best mode and are not intended to otherwise limit the scope of the present invention in any way. Although the present invention was discussed in terms of certain preferred embodiments, the invention is not limited to such embodiments. A person of ordinary skill in the art will appreciate that numerous variations and combinations of the features set forth above can be utilized without departing from the present invention as set forth in the claims. Indeed, for the sake of brevity, conventional data networking, application development, other functional aspects of the systems, and components of the individual operating components of the systems are not described in detail herein. It should be noted that many alternative or additional functional relationships or physical connections may be present in a practical electronic transaction system. Thus, the scope of the invention should not be limited by the preceding description but should be ascertained by reference to claims that follow.

I claim:

1. A membership-based travel discount service that offers its participants discounts or travel-related benefits and services in return for a subscription.

2. The method of claim 1, wherein said travel discount is offered at any time prior to travel.

3. The method of claim 1, wherein said travel discount is offered without the need for advanced booking or prior reservation.

4. The method of claim 1, wherein said travel discount is offered with one or more airline company.

5. The method of claim 1, wherein the travel-related benefits and services are obtained upon a showing of subscription.

6. The method of claim 1, wherein use of the discount or travel-related benefits and services by the participant is reported back to the membership provider to update the history of purchase by the participant.

7. A method for travel discount, comprising: offering participation by payment of a predetermined subscription, obtaining discounts and services from airline and travel-services providers, and passing such discounts and services to each individual participant member.

8. The method of claim 7, wherein the predetermined subscription may be of different amounts and levels.

9. The method of claim 7, wherein the predetermined subscription corresponds to a specific plan.

10. The method of claim 7, wherein the predetermined subscription varies with and corresponds to the amounts of discounts and magnitude of other offered travel-related services and benefits.

11. The method of claim 7, wherein the discounts are negotiated with or obtained from airline tickets and other travel-related services providers.

12. The method of claim 7, wherein the discounts are purchased in advance, reimbursed wholly or partially, or paid as a percentage of the actual discounts used.

13. A method of selling discounted tickets and other travel-related benefits and services for participating members in return for a subscription.

14. The method of claim 13, wherein the discounted tickets and travel-related services are offered at the time of purchase by the airline ticket or travel-related services providers upon presentation of the member's subscription.

15. The method of claim 13, wherein the member's purchase history is updated upon transmission of discount and other travel-related services by the airline or travel-related services provider to the subscription provider.

16. A system for selling discounted airline tickets and other travel-related services, the system comprising: an integrated network of providers of discounted airline tickets and other travel-related services; at least one subscription plan offered for use of network discounts and services; a network database of subscribers and network discount providers, wherein the discount network providers offer subscribers airline discounts and travel services upon the presentation of subscription; updating the subscriber's travel history database, wherein the travel history database is configured to store information about the subscribers' transactions; and at least one point of service terminal connected to the network, wherein the point of service terminal is configured to access the discount and travel-related providers' databases.

17. The system of claim 16, wherein the discount and travel-service providers are connected to the membership provider database.

18. A system for selling discounted airline tickets and other travel-related services, the system comprising: an integrated network of providers of discounted airline tickets and other travel-related services; at least one subscription plan offered for use of such networked discounts and services providers; a membership database of subscribers and network discount providers, wherein the membership provider offers subscribers discounted airline tickets and other travel-related services upon request and updates the subscribers' purchase history upon providing such discounts and services till the benefits and privileges of the subscription are exhausted.

19. The system of claim 18, wherein the discounted airline tickets and other travel-related services are obtained by the membership provider.

20. The system of claim 18, wherein the discounted airline tickets and other travel-related services are offered to participant members by the membership provider directly.

21. The system of claim 18, wherein the subscribers' history of purchase is updated upon offering each discount on airline tickets and travel-related service.
